(19) United States
(12) Patent Application Publication
(10) Pub. No.: US 2012/0106638 A1
(43) Pub. Date: May 3, 2012

(54) Decoder-Side Motion Derivation with Motion Vector Predictors

(76) Inventor: Yeping Su, Camas, WA (US)

(21) Appl. No.: 12/915,475

(22) Filed: Oct. 29, 2010

(51) Int. Cl. H04N 11/02; H04N 7/26

(52) U.S. Cl. 375/240.16; 375/E07.105; 375/E07.123

(57) ABSTRACT

Systems and devices for, and methods of, decoder-side motion derivation with motion vector predictors. A method embodiment includes (a) determining a starting motion vector predictor by a processor having addressable memory, where the memory comprises a set of two or more motion vector predictors; and where the determining of the starting motion vector predictor is based on a received index and the set of two or more motion vector predictors; (b) and determining a motion-compensated predictor based on the determined starting motion vector predictor, a cost function, and a search region.

### FIELD OF ENDEAVOR

Embodiments pertain to systems and devices for, and methods of, motion derivation with motion vector predictors.

### BACKGROUND

In video coding, data compression may be achieved by removing both temporal and spatial redundancy. Video coding may use prediction and/or block-based motion compensation that may be used to reconstruct an approximation of the video data with minimal bits. A motion vector for a given video block may be differentially coded with respect to a spatial filter—choosing from multiple motion vector predictors. Motion vectors may be derived at the decoder side based on a causal neighborhood available at both the encoder and decoder.

### SUMMARY

Embodiments include systems and devices for, and methods of, decoder-side motion derivation with motion vector predictors. For example, a method embodiment includes (a) determining a starting motion vector predictor by a processor having addressable memory, where the memory is a set of two or more motion vector predictors; and where the determining of the starting motion vector predictor is based on a received index and the set of two or more motion vector predictors; and (b) determining a motion-compensated predictor based on the determined starting motion vector predictor, a cost function, and a search region. Optionally, the determining of the motion-compensated predictor may be based on a minimal cost value of the cost function. In some embodiments the search region may be defined by the motion vector predictor and a search range.

Some embodiments pertain to devices for decoder-side motion derivation with motion vector predictors, for example, the device embodiment may comprise: a computer processor comprising: a processor; and an addressable memory, the memory having a set of two or more motion vector predictors; and the processor configured to: (a) determine a starting motion vector predictor based on a received index and the set of two or more motion vector predictors; and (b) determine a motion-compensated-predictor based on the determined starting motion vector predictor, a cost function, and a search region. In some embodiments, the processor may be further configured to determine the motion-compensated predictor based on a minimal cost value of the cost function. Optionally, the search region may be defined by the motion vector predictor and a search range.

Another exemplary method embodiment of a decoder-side motion derivation with motion vector predictors may include the steps of: (a) for each of two or more motion vector predictors comprising a predictor set: (i) determining a motion-compensated predictor member, of a set of motion-compensated predictors, by a processor having addressable memory, where the memory comprises a set of two or more motion vector predictors, and where the determining based on the motion vector predictor, a cost value based on a cost function, and a search range; and (ii) determining a refined motion-compensated predictor based on the cost value of each member of the motion-compensated predictor set. Optionally, the determining of the set of motion compensated predictors and associated costs may be based on a minimal cost value. In one embodiment, the search region may be defined by the motion vector predictor and a search range.

Some embodiments pertain to devices for decoder-side motion derivation with motion vector predictors, for example, the device embodiment may comprise: a computer processor comprising: a processor; and an addressable memory, the memory having a set of two or more motion vector predictors; and the processor configured to, for each of two or more motion vector predictors comprising a predictor set: (a) determine a motion-compensated predictor member of a set of motion-compensated predictors based on the motion vector predictor, a cost value based on a cost function, and a search range; and (b) determine a refined motion-compensated predictor based on the cost values of each member of the motion-compensated predictor set. Optionally, the processor may be further configured to determine the motion-compensated predictor based on a minimal cost of the cost function. In one embodiment, the search region may be defined by the motion vector predictor and a search range.

Another exemplary method embodiment of a decoder-side motion derivation with motion vector predictors may include the steps of: (a) determining a motion vector predictor and a search range by a processor having addressable memory, where the memory comprises a set of two or more motion vector predictors; and where the determining of the motion vector predictor and the search range is based on a search region comprising, e.g., bounding or extending a few pixels beyond a bounding box and containing, the set of two or more motion vector predictors; and (b) determining a motion-compensated predictor based on the determined motion vector predictor, a cost function, and the determined search range. Optionally, the determining of the motion-compensated predictor may be based on a minimal cost value of the cost function.

Some embodiments pertain to devices for decoder-side motion derivation with motion vector predictors, for example, the device embodiment may comprise: a computer processor comprising: a processor; and an addressable memory, the memory having a set of two or more motion vector predictors; and the processor configured to (a) determine a motion vector predictor and a search range based on a search region that bounds the set of two or more motion vector predictors; and (b) determine a motion-compensated predictor based on the determined motion vector predictor, a cost function, and the determined search range. Optionally, the processor may be further configured to determine the motion-compensated predictor based on a minimal cost of the cost function.

### BRIEF DESCRIPTION OF THE DRAWINGS

Embodiments are illustrated by way of example and not limitation in the figures of the accompanying drawings, and in which:

FIG. 1 depicts in a top-level functional block diagram an embodiment of a video encoder-decoder.

FIG. 2 depicts a temporal and spatial motion of a pixel in a set of frames.

FIG. 3 is an exemplary functional block diagram depicting an embodiment of a video decoding system;

FIG. 4 is a flowchart of an exemplary process;

FIG. 5 depicts a functional block diagram of an exemplary decoder side motion derivation;

FIG. 6 is a flowchart of an exemplary process;

FIG. 7 is an exemplary functional block diagram depicting an embodiment of a video decoding system;

FIG. 8 is a flowchart of an exemplary process;

FIG. 9 depicts a functional block diagram of a video decoding system with variable search regions; and

FIG. 10 is a flowchart of an exemplary process.

### DETAILED DESCRIPTION

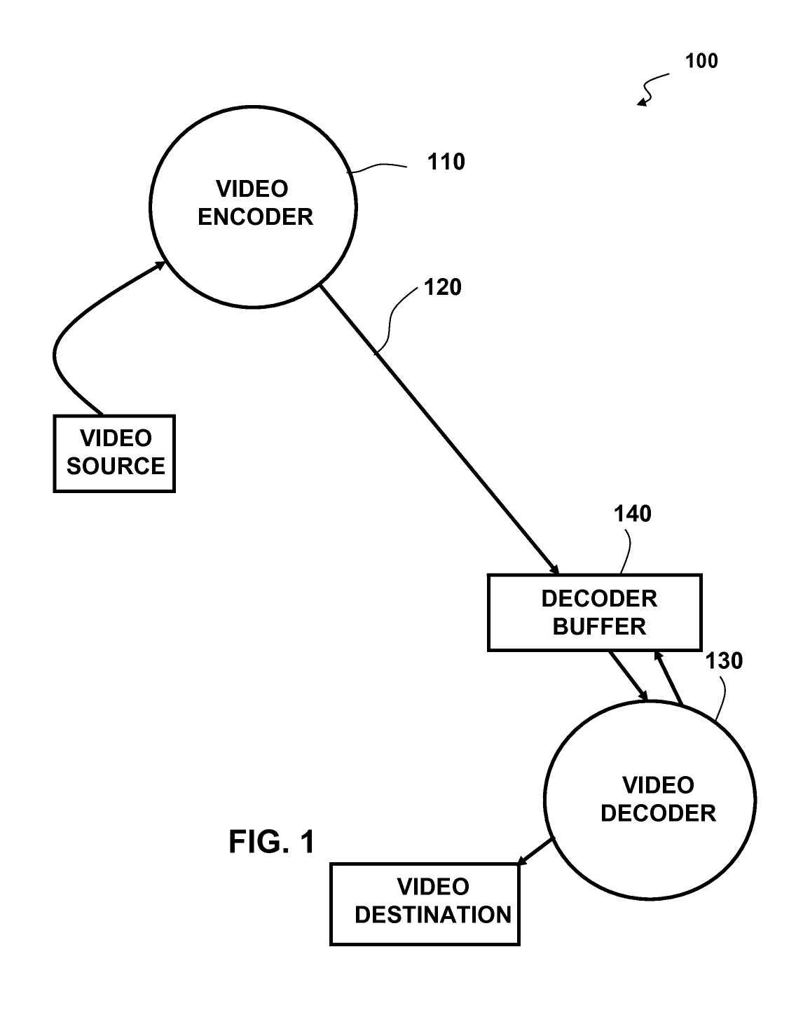

FIG. 1 depicts in a top-level functional block diagram an embodiment of a video coding system 100 having an encoder-decoder. A video encoder 110 may receive a video stream as input and transmit the encoded frames on a bitstream 120. A video decoder 130 may then decode the video stream received from the bitstream according to, for example, a decoder side motion derivation technique based on a causal neighborhood available to both the encoder and decoder. The decoder may further store previous frames in a decoder buffer 140 that may be drawn from to create a predictor set of frames.

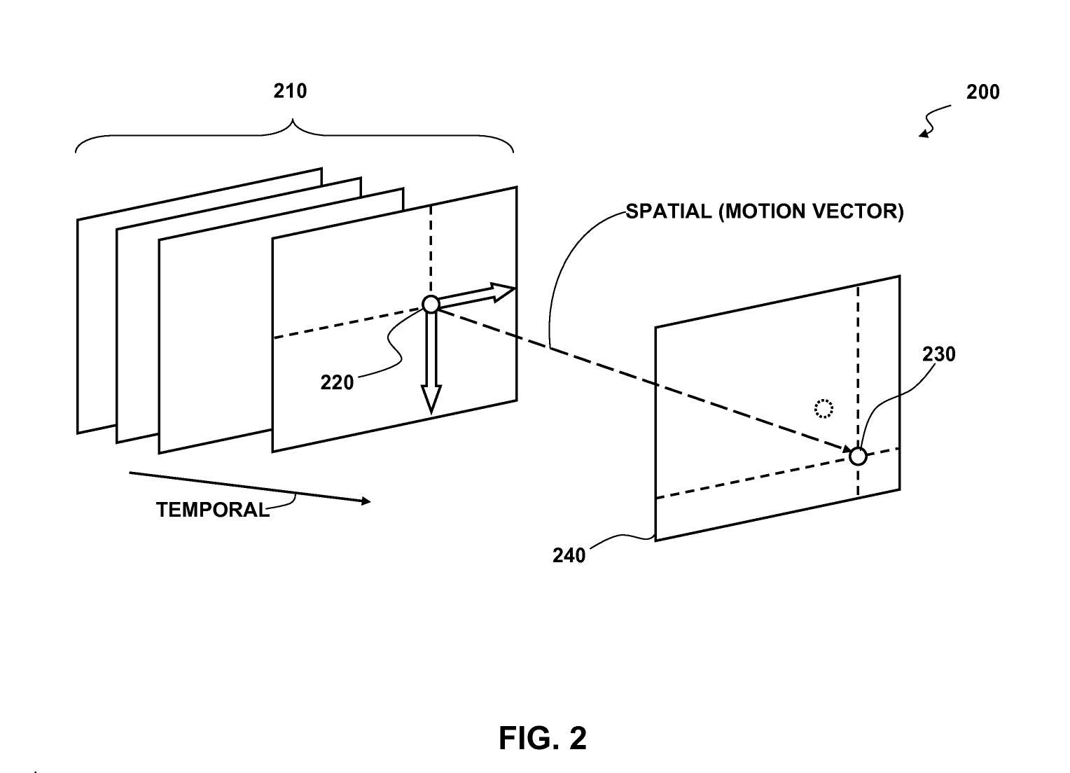

FIG. 2 depicts a temporal and spatial motion 200 of a pixel in a set of frames 210. The set of frames 210 may be depicted as time frames, and the corresponding pixels as having different intensity across the frames. An encoder or decoder may create a motion-compensated prediction for a pixel 220 in a frame based on motion vectors and a set of predictors based on a set of reference frames. The set of predictors may be referenced via a reference index and motion vectors may indicate an offset from a current block. In one example, a motion vector having horizontal and vertical components may be signaled for a specific block partition, where each vector component may indicate an offset 230 to a region in the reference frame 240. The region may be of the same size in a reference frame and form the prediction for the current partition.

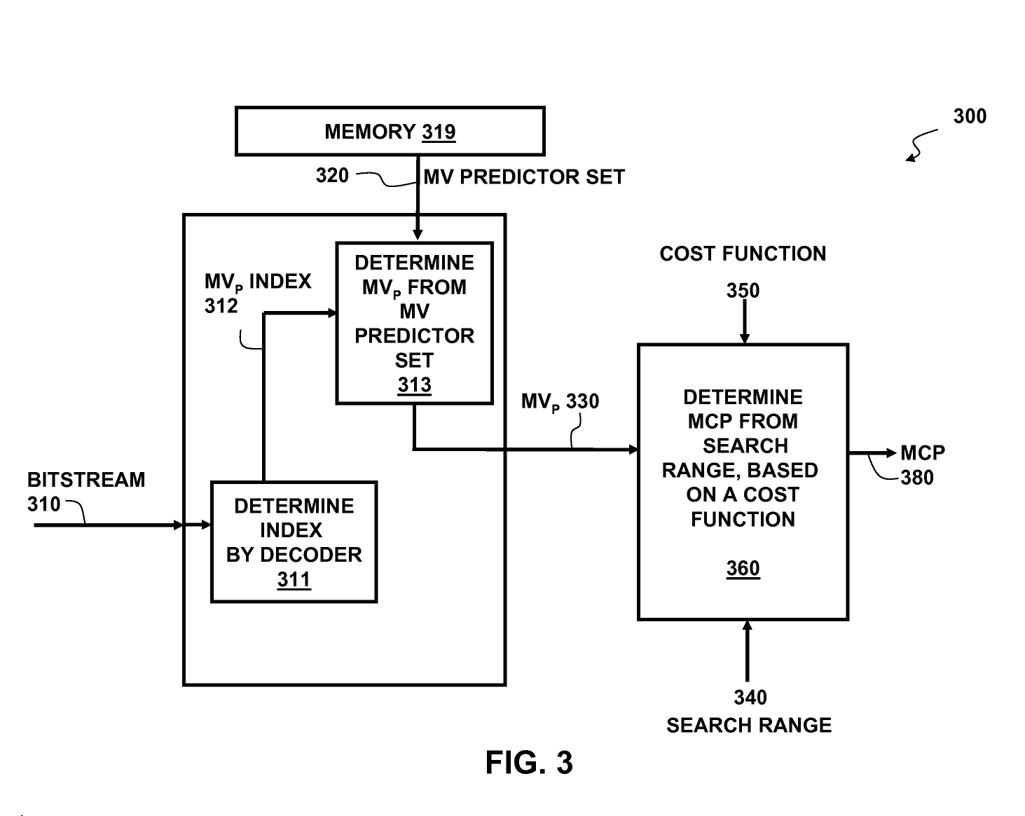

FIG. 3 is an exemplary functional block diagram depicting an embodiment of a video decoding system 300. Embodiments of the video coding system 300 may be executed in real time or near real time, and a bitstream 310 may be received, read, or accessed, that may carry one or more encoded frames. A motion vector predictor set 320 may be based on a candidate set of spatial, temporal, and/or spatio-temporal predictors. The predictor set 320 may be stored in memory 319, for example, a buffer, and may be based on previously calculated motion vectors, e.g., indexed predictor set 320 of two or more motion vectors based on associated previous motion vectors. A size of a neighborhood region may have been predetermined or the decoder side may have received the size of the region from a higher level syntax. In one embodiment, a decoder may decode the bitstream 310 and determine an index (block 311)—the index 312 may indicate which predictor to select for motion vector decoding. A motion vector predictor (MVₚ) 330 may be selected (block 313) from a predictor set by indexing the predictor set 320 with the provided index 312. A cost function 350 may be predetermined and/or signaled on a higher level, e.g., slice level or picture level that may, for example, be based on a goodness-of-fit measurement. A decoder side motion derivation 360 may determine a motion compensated predictor (MCP) 380 for the current block based on the MVₚ 330—which may be a starting motion vector—the cost function 350, and a search range 340.

In one embodiment, the prediction function may be performed using sub-pixel accuracy—via sub-pixel motion compensation—where the reference frames may be up-scaled by a factor in both spatial dimensions. That is, an optional motion search algorithm may perform an integer-pixel stage along with a sub-pixel stage. For example, one optional integer-pixel strategy may be to search all integer pixel positions in the search region and then determine the best integer pixel position. Based on the determined best integer pixel position, a best half-pixel position may be determined by searching the adjacent half-pixel locations—for example, the nine adjacent pixels. This process may optionally be repeated for quarter-pixel searches. Embodiments may apply a variety of other search strategies, for example, a three-step search or any other fast search strategy.

A reference index may indicate which reference frame may be used in determining the motion compensated predictor. That is, the set of predictors may be dependant on the reference index of the current block. The reference index may be decoded from the bitstream or optionally derived as part of the decoder side motion derivation search process. The reference index may be parsed from the bitstream to determine the MVₚ. For example, there may be 32 spatial neighboring blocks, 20 of which may have a reference index of “0” and the remaining 12 may have a reference index of “1.” The current block may then be parsed where a reference index of “1” may signal that only 12 spatial motion vector predictors may be included in the MVₚ set. The motion vector predictor set may be comprised of identical and non-identical motion vector predictors where for processing purposes only the non-identical motion vector predictor elements of the set of predictors are applied. For example, a predictor set may have five identical vectors and for processing purposes the predictor set may be treated as having a single motion vector.

Optionally, in an embodiment with template matching, there may not be a need to code a reference index into the bitstream for a specific block. The same MV derivation may be performed at the encoder and decoder side; therefore, the encoder may need to signal that a decoder side motion derivation may be performed in order to derive motion vectors and reference indices. In this example, instead of explicitly coding the information into the bitstream, the information is derived.

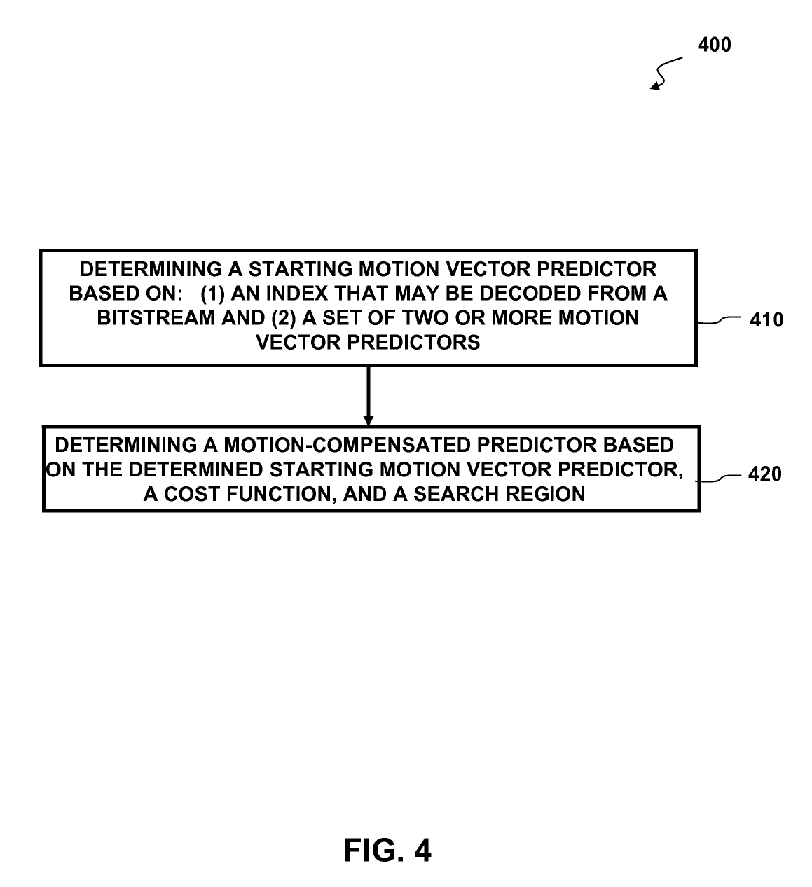

FIG. 4 is a flowchart of an exemplary process 400 in which the system comprises a computer and/or computing circuitry that may be configured to execute the steps as depicted. The method depicted in the flowchart of FIG. 4 comprises the steps of: (a) determining a starting motion vector predictor based on (1) an index that may be decoded from a bitstream and (2) a set of two or more motion vector predictors (step 410); and (b) determining a motion-compensated predictor based on the determined starting motion vector predictor, a cost function, and a search region (step 420). The process may have the determining of the motion-compensated predictor based on a minimal cost value of the cost function. Also the process may have the determining of a motion compensated predictor for the current block wherein the search region may be defined by the motion vector predictor and a search range.

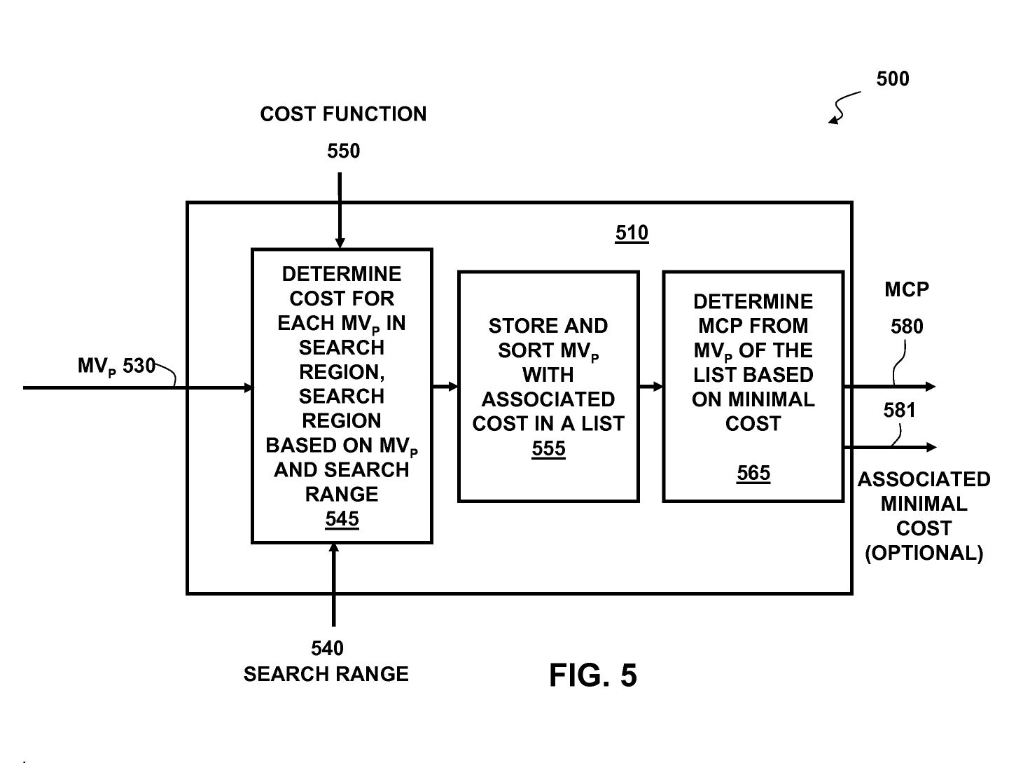

FIG. 5 depicts a functional block diagram of an exemplary decoder side motion derivation 500. In this embodiment, a motion vector predictor (MVₚ) 530, a search range 540, and a cost function 550 may be optionally received as an input. A cost for each MVₚ 530 in the search region may be determined (block 545). The region may also be searched based on the MVₚ and the search range (block 545). A motion compensated predictor (MCP) 580 of the search region 547 and an optional associated minimal cost 581 for the current block may be based on the MVₚ and the associated costs. For example, the motion vector predictors and the associated costs may be stored and sorted as a set of motion vectors to generate an indexed set (block 555). The motion vectors, e.g., k number of motion vector predictors, associated with the lowest costs may be stored as the top candidates. In some embodiments, determining the MCP 580 may be done by populating a buffer with the MVₚ set and associated costs which may then be used to determine the motion compensated predictor of subsequent pixels (block 565).

In one embodiment a cost routine which may calculate the cost may take as input a cost function that may determine the goodness of fit, for example, the sum of absolute difference between pixels of the neighboring region and the corresponding displaced region in the reference frames. Other cost functions, e.g., sum of squared difference, may be also be used for calculating the cost. In some embodiments, different candidate sets, e.g., prediction motion vectors and/or multiple reference frames may be used to determine the set. In an embodiment where all the previously coded slices are available as reference frames, a candidate set of multiple reference frames may be used. The encoder may search up to N number of reference frames in a candidate set to find the best matching predictor vector. In this embodiment, the N number of reference frames may be stored at the encoder and/or decoder.

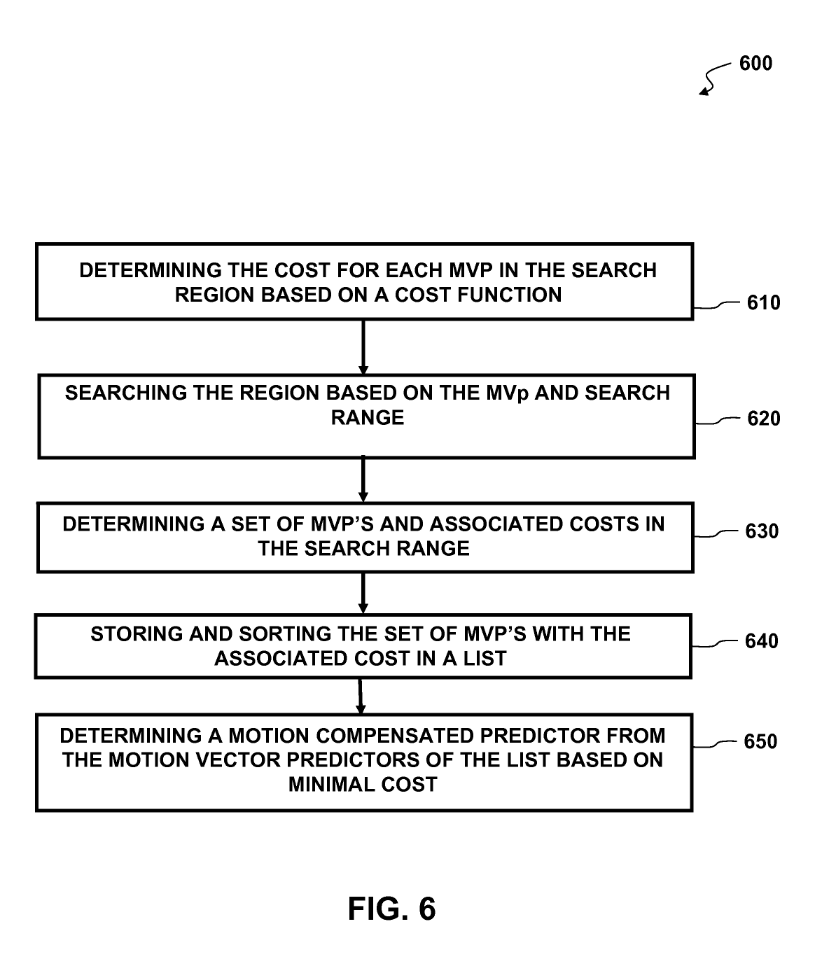

FIG. 6 is a flowchart of an exemplary process 600 in which the system comprises a computer and/or computing circuitry that may be configured to execute the steps as depicted. The method depicted in the flowchart includes the steps of: (a) determining a cost for each motion vector predictor in the search region based on a cost function (step 610); (b) searching the region based on the motion vector predictor and the search range (step 620); (c) determining a set of motion vector predictors and associated costs in the search range (step 630); (d) storing and sorting the set of motion vector predictors with the associated cost in a list (step 640); and (e) determining a motion compensated predictor from the motion vector predictors of the list based on the selected motion vector position with minimum cost (step 650).

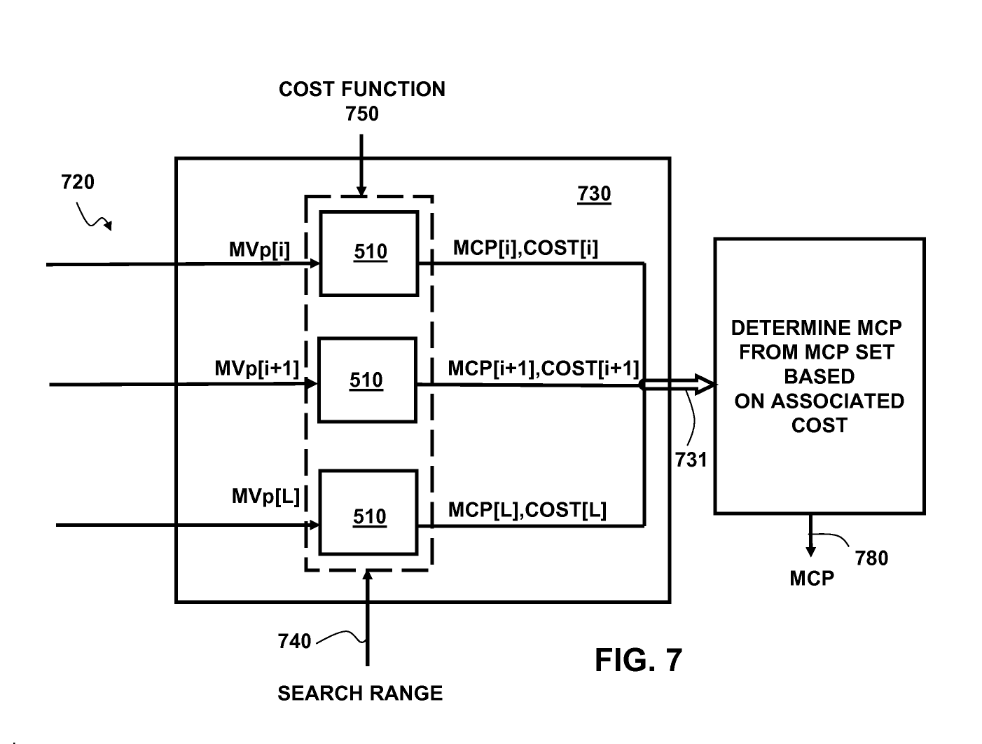

FIG. 7 is an exemplary functional block diagram depicting an embodiment of a video coding system 700. A decoder side motion derivation may be performed to determine the motion vector predictor. In one embodiment, two or more motion vector predictors 720 of the neighboring blocks, i.e., set of motion vector candidates, may be each processed according to the process example 510 of FIG. 5 (block 730), where a motion compensated predictor and a cost value are determined. A search range 740 may be signaled on a higher-level, e.g., slice level and/or picture level. In some embodiments, a motion compensated predictor and an associated cost may be determined for each of the pixels in the search range 740, based on a predetermined cost function 750, e.g., the best cost obtained during the decoder side motion derivation search on each MVₚ. In one embodiment, a motion compensated predictor 780 for the current block may be selected from a set of motion compensated predictors along with the associated costs of each of the motion compensated predictors (MCP). The MCP 780 for the current block, of the set of motion compensated predictors, may then have the minimum cost. For example, a final motion compensated predictor 780 may be based on a minimal cost which may be the same as one used to generate the set of motion compensated predictors. In some embodiments the each motion compensated predictor of the predictor set may be determine via selecting the MCP of each search range 740 based on an associated cost function 750 (block 510). The MCP for the current block may then be selected based on the cost function—picking the predictor with the minimal cost—and the set of motion compensated predictors.

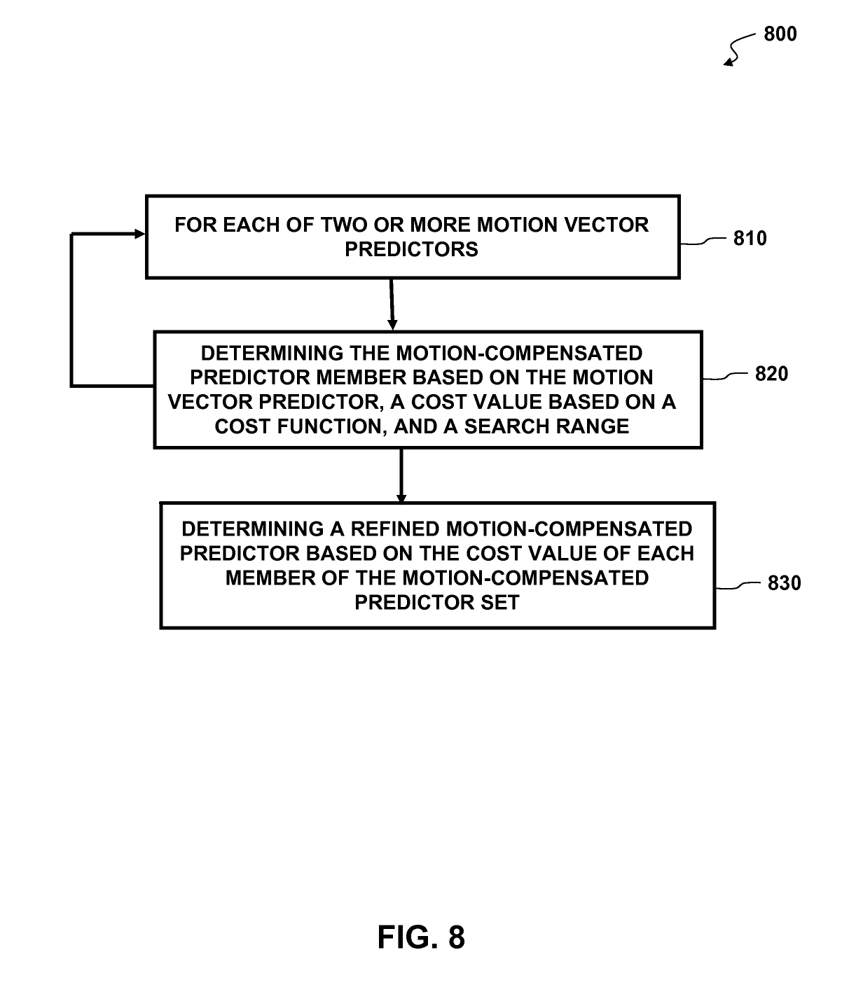

FIG. 8 is a flowchart of an exemplary process 800 in which the system comprises a computer and/or computing circuitry that may be configured to execute the steps as depicted. The method depicted in the flowchart includes the steps of: (a) determining a motion-compensated predictor member, of a set of motion-compensated predictors for each of two or more motion vector predictors comprising a predictor set (step 810); (b) determining the motion-compensated predictor member based on the motion vector predictor, a cost value based on a cost function, and a search range (step 820); and (c) determining a refined motion-compensated predictor based on the cost value of each member of the motion-compensated predictor set (step 830). The process may have the determining of the set of motion-compensated predictors and associated costs based on a minimal cost value. Also the process may have the determining of the motion-compensated predictor for the current block where the search region may be defined by the motion vector predictor and a search range.

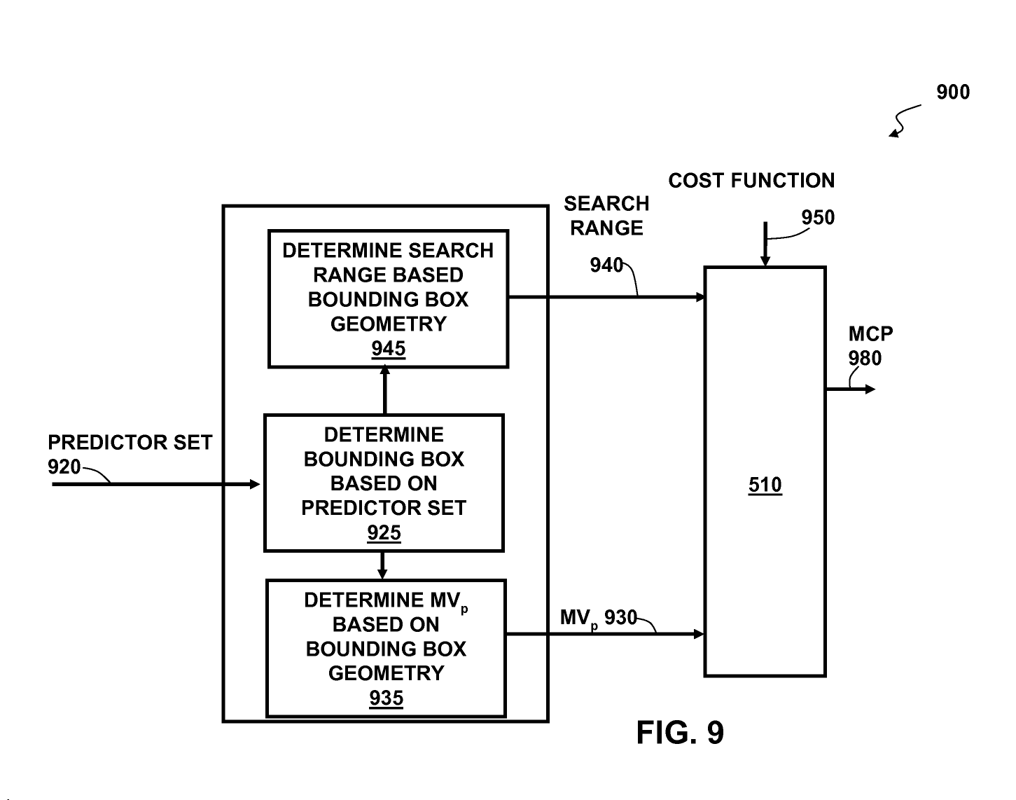

FIG. 9 depicts a functional block diagram of a video coding system 900 with variable search regions. A predictor set 920 may be provided from the buffer and a search region analysis may be performed to determine a search range 940 based on the motion vector predictor set 920. In one embodiment, the search region may be variable and may be selected to be a minimal bounding area which may include all motion vector predictor candidates of the predictor set 920. A bounding region, e.g., a two dimensional box bounding may be determined based on the predictor set 920 (block 925). The search range 940 may then be determined based on the bounding region (block 945). A motion vector predictor may be determined based on the bounding region (block 935). A motion-compensated predictor 980 may then be selected based on the motion vector predictor 930, the search range 940, and a predetermined cost function 950. In some embodiments the same search process may be carried out for all possible locations within the bounding area and a cost function may determine the best position. The decoder side motion derivation (block 510) may then determine the motion-compensated predictor for the current block. In some embodiments the search range 940 may be derived from the motion vector predictor set 920 and thereby may not be received from the bitstream. For example, implementation of the variance in the search range may generate different search ranges for different macro-block types which may yield better coding efficiency than using a fixed size search range.

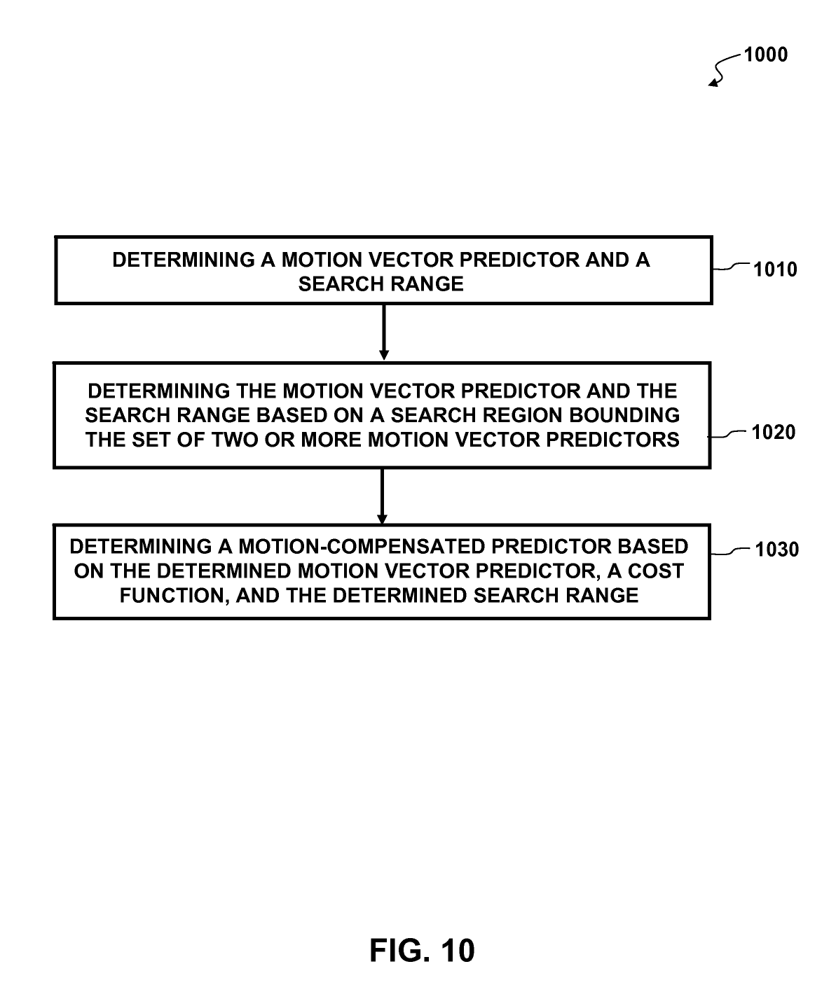

FIG. 10 is a flowchart of an exemplary process 1000 in which the system comprises a computer and/or computing circuitry that may be configured to execute the steps as depicted. The method depicted in the flowchart includes the steps of: (a) determining a motion vector predictor and a search region for decoder side motion derivation based on a motion vector predictor set (step 1010); (b) determining the motion vector predictor and the search range based on a search region bounding the set of two or more motion vector predictor (step 1020); and (c) determining a motion-compensated predictor based on the determined motion vector predictor, a cost function, and the determined search range (step 1030). The process may have the determining of the motion-compensated predictor of the current block based on a minimal cost value of the cost function.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A method comprising:
determining a starting motion vector predictor by a processor having addressable memory, wherein the memory comprises a set of two or more motion vector predictors; and wherein the determining of the starting motion vector predictor is based on a received index and the set of two or more motion vector predictors; and
determining a motion-compensated predictor based on the determined starting motion vector predictor, a cost function, and a search region.

2. The method of claim 1 wherein the determining of the motion-compensated predictor is based on a minimal cost value of the cost function.

3. The method of claim 1 wherein the search region is defined by the motion vector predictor and a search range.

4. A device comprising:
a computer processor comprising:
a processor;
an addressable memory, the memory comprising a set of two or more motion vector predictors; and the processor configured to:
determine a starting motion vector predictor based on a received index and the set of two or more motion vector predictors; and
determine a motion-compensated-predictor based on the determined starting motion vector predictor, a cost function, and a search region.

5. The device of claim 4 wherein the processor is further configured to determine the motion-compensated predictor based on a minimal cost value of the cost function.

6. The device of claim 4 wherein the search region is defined by the motion vector predictor and a search range.

7. A method comprising:
for each of two or more motion vector predictors comprising a predictor set:
determining a motion-compensated predictor member, of a set of motion-compensated predictors, by a processor having addressable memory, wherein the memory comprises a set of two or more motion vector predictors, and wherein the determining based on the motion vector predictor, a cost value based on a cost function, and a search range; and
determining a refined motion-compensated predictor based on the cost value of each member of the motion-compensated predictor set.

8. The method of claim 7 wherein the determining of the set of motion-compensated predictors and associated costs is based on a minimal cost value.

9. The method of claim 7 wherein the search region is defined by the motion vector predictor and a search range.

10. A device comprising:
a computer processor comprising:
a processor;
an addressable memory, the memory comprising a set of two or more motion vector predictors; and the processor configured to:
for each of two or more motion vector predictors comprising a predictor set:
determine a motion-compensated predictor member of a set of motion-compensated predictors based on the motion vector predictor, a cost value based on a cost function, and a search range; and
determine a refined motion-compensated predictor based on the cost values of each member of the motion-compensated predictor set.

11. The device of claim 10 wherein the processor is further configured to determine the motion-compensated predictor based on a minimal cost of the cost function.

12. The device of claim 11 wherein the search region is defined by the motion vector predictor and a search range.

13. A method comprising:
determining a motion vector predictor and a search range by a processor having addressable memory, wherein the memory comprises a set of two or more motion vector predictors; and wherein the determining of the motion vector predictor and the search range is based on a search region comprising the set of two or more motion vector predictors; and
determining a motion-compensated predictor based on the determined motion vector predictor, a cost function, and the determined search range.

14. The method of claim 13 wherein the determining of the motion-compensated predictor is based on a minimal cost value of the cost function.

15. A device comprising:
a computer processor comprising:
a processor;
an addressable memory, the memory comprising a set of two or more motion vector predictors; and the processor configured to:
determine a motion vector predictor and a search range based on a search region that bounds the set of two or more motion vector predictors; and
determine a motion-compensated predictor based on the determined motion vector predictor, a cost function, and the determined search range.

16. The device of claim 15 wherein the processor is further configured to determine the motion-compensated predictor based on a minimal cost of the cost function.
